(19) United States
(12) Patent Application Publication
(10) Pub. No.: US 2025/0367739 A1
(43) Pub. Date: Dec. 4, 2025

(54) Metal drill bit and method

(71) Applicant: Hilti Aktiengesellschaft, Schaan (LI)

(72) Inventors: Andreas WETTSTEIN, Feldkirch (AT); Pauric DOHERTY, Zurich (CH); Elise JANSSEN, Feldkirch (AT); Pablo NIESUTTA, Buchs (CH)

(21) Appl. No.: 18/870,863

(22) PCT Filed: Jun. 13, 2023
(86) PCT No.: PCT/EP2023/065794

§ 371 Date: Dec. 2, 2024

(30) Foreign Application Priority Data
Jun. 28, 2022 (EP) 22181712.5

(51) Int. Cl. B23B 51/00

(52) U.S. Cl. CPC B23B 51/0007

(57) ABSTRACT

A drill bit (10) for hand-guided drilling of a blind hole with a blind hole diameter and a blind hole depth into a metal workpiece, including a shank (20) which defines a drilling direction (30) and has an axis of rotation oriented in the drilling direction, wherein the shank has a cutting edge (50) at its end pointing in the drilling direction and has a stop shoulder (55) at a distance from the cutting edge defining the blind hole depth and measured counter to the drilling direction, wherein the cutting edge defines the blind hole diameter by rotation about the axis of rotation, wherein the shank has an enveloping circle diameter that changes along the axis of rotation and is larger at the stop shoulder than the blind hole diameter, wherein the shank has a first shank section (40) which adjoins the stop shoulder counter to the drilling direction and which reaches up to the stop shoulder and in which the enveloping circle diameter, starting from the stop shoulder, increases counter to the drilling direction.

The present invention relates to a drill bit for hand-guided drilling of a blind hole into a metal workpiece.

### BACKGROUND

Drill bits are known which have a shank defining a drilling direction with a cutting edge and a stop shoulder, the distance between which defines a blind hole depth. The stop shoulder usually has an edge which creates a hole with a sharp-edged border in a cover layer of a workpiece that may be present. A sealing ring, which may later cover the hole, can be damaged by the edge.

### SUMMARY OF THE INVENTION

An object of the invention is to provide a drill bit with which the risk of damage to a sealing element is reduced.

The present invention provides a drill bit for hand-guided drilling of a blind hole with a blind hole diameter and a blind hole depth into a metal workpiece, comprising a shank which defines a drilling direction and has an axis of rotation oriented in the drilling direction, wherein the shank has a cutting edge at its end pointing in the drilling direction and has a stop shoulder at a distance from the cutting edge defining the blind hole depth and measured counter to the drilling direction, wherein the cutting edge defines the blind hole diameter by rotation about the axis of rotation, wherein the shank has an enveloping circle diameter that changes along the axis of rotation and is larger at the stop shoulder than the blind hole diameter, wherein the shank has a first shank section which adjoins the stop shoulder counter to the drilling direction and which reaches up to the stop shoulder and in which the enveloping circle diameter, starting from the stop shoulder, increases, preferably continuously, counter to the drilling direction. The shank preferably has two or more cutting edges at its end pointing in the drilling direction, which jointly define the blind hole diameter by rotation about the axis of rotation and are particularly preferably arranged symmetrically about the axis of rotation.

An enveloping circle diameter within the meaning of the invention is the diameter of the smallest possible circle which still completely envelops the shank with a circle center on the axis of rotation. In other words, for any point along the axis of rotation, the area of the enveloping circle is the area covered by the shank when rotated about the axis of rotation. In the case of a circular circumferential line, the enveloping circle diameter is equal to the diameter of the circumferential line, i.e. the shank diameter. Inward deviations of the circumferential line from the circular shape do not affect the enveloping circle diameter, while outward deviations increase the enveloping circle diameter.

In a preferred embodiment, the shank has a centering point at its end pointing in the drilling direction, through which the axis of rotation runs.

In a preferred embodiment, the stop shoulder has a stop surface which is oriented perpendicular to the axis of rotation and points in the drilling direction.

In a preferred embodiment, the shank has, at its end pointing counter to the drilling direction, a fastening section for temporary fastening to a hand-held drilling machine. The fastening section is particularly preferably designed as an insertion end.

In a preferred embodiment, the first section has a conical shape. An opening angle of the conical shape is preferably at least 60°, particularly preferably at least 90° or at least 120°.

In a preferred embodiment, the first section extends along the axis of rotation over at least 0.5 mm, preferably at least 1.0 mm, particularly preferably at least 1.5 mm or at least 2.0 mm.

The object is also achieved with a method for fastening a fastening element to a workpiece, in which a workpiece having a cover layer and a drill bit are provided as stated above, a blind hole is drilled through the cover layer into the workpiece by means of the drill bit, wherein the first shank section of the drill bit creates a hole in the cover layer that increases in size counter to the drilling direction, wherein furthermore a fastening element having a sealing element is provided and is driven into the blind hole, wherein the sealing element is pressed against the hole in the cover layer. The fastening element is preferably screwed into the blind hole.

### BRIEF DESCRIPTION OF THE DRAWINGS

The invention will be explained in more detail below with reference to the drawings, in which:

FIG. 1 shows a drill bit,

FIG. 2 shows a workpiece,

FIG. 3 shows a drilling machine with a fastening element, and

FIG. 4 shows a workpiece with a sealing element.

### DETAILED DESCRIPTION

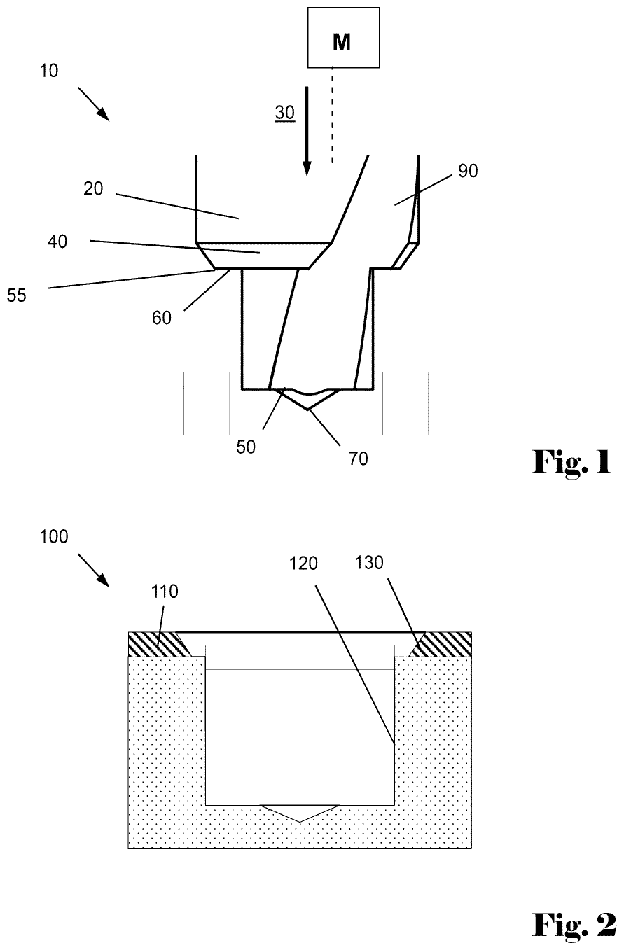

FIG. 1 shows a side view of a drill bit 10, which is suitable for hand-guided drilling of a blind hole into a metal workpiece.—The drill bit 10 comprises a shank 20 which defines a drilling direction 30 and has an axis of rotation oriented in the drilling direction 30. At its end pointing in the drilling direction 30, the shank 20 has a cutting edge 50 and a further cutting edge, which are arranged opposite one another and symmetrically in relation to the axis of rotation and together define a blind hole diameter of the drilled blind hole by rotation about the axis of rotation. Furthermore, the shank 20 has a stop shoulder 55 with a stop surface 60 oriented perpendicular to the axis of rotation and pointing in the drilling direction 30. During the drilling of the blind hole, the stop shoulder 55 strikes a surface of the workpiece, so that the distance between the stop surface 60 and the cutting edge 50 measured counter to the drilling direction 30 defines a blind hole depth of the drilled blind hole. At its end pointing counter to the drilling direction 30, the shank 20 has an insertion end 31 shown solely schematically for temporary fastening to a hand-held drilling machine M.

The shank 20 has an enveloping circle diameter that changes along the axis of rotation. At the stop shoulder 55, the enveloping circle diameter is larger than the blind hole diameter. Furthermore, the shank 20 has a centering point 70 at its end pointing in the drilling direction 30, through which the axis of rotation runs. The entire shank 20 including the cutting edge 50 and the centering point 70 is formed in one piece, so that the stop shoulder 55 and the cutting edge 50 are made of the same material, preferably a metal or an alloy, particularly preferably a steel.

For the removal of metal chips which are generated during drilling by the cutting edge 50 and the further cutting edge, the shank 20 has two helical grooves 90 which extend through the stop shoulder 55 and are delimited by the cutting edge 50 and by the further cutting edge.

The shank 20 has a first shank section 40 which adjoins the stop shoulder 55 counter to the drilling direction 30 and which reaches up to the stop shoulder 55 and in which the enveloping circle diameter, starting from the stop shoulder 55, increases continuously counter to the drilling direction 30. The first shank section has a conical shape with an opening angle of 140° and extends along the axis of rotation over 2.5 mm.

FIG. 2 shows a workpiece 100 with a cover layer 110. The workpiece has a blind hole 120, which was produced, for example, by means of the drill bit 10 from FIG. 1. The first shank section of the drill bit has produced a hole 130 in the cover layer, which increases in size counter to the drilling direction.

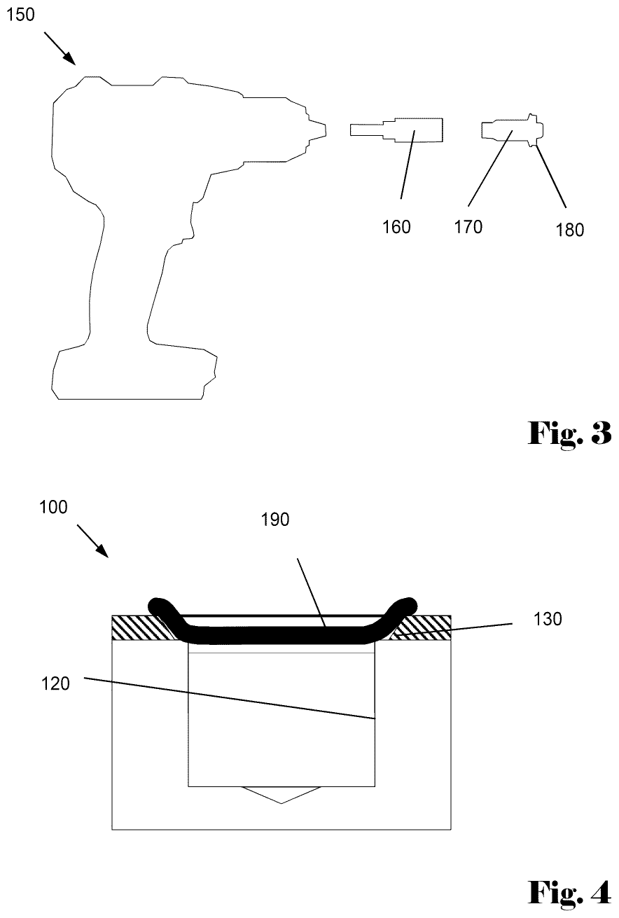

FIG. 3 shows a drilling machine 150 with a bit holder 160 and a fastening element 170, which has a sealing element 180 designed as a sealing ring and is driven into the blind hole 120 from FIG. 2, for example.

FIG. 4 shows the workpiece 100 with the cover layer 110 after a fastening element, of which only a sealing element 190 is illustrated, has been driven into the blind hole 120. The sealing element 190 is pressed against the hole 130 in the cover layer, which increases in size counter to the drilling direction. Owing to the conical shape of the hole 130, the sealing element 190 is protected against excessive loading.

The invention has been described using the example of a metal drill bit. However, it is pointed out that the drill bit according to the invention is also suitable for other purposes.

1-10. (canceled)

11. A drill bit for hand-guided drilling of a blind hole with a blind hole diameter and a blind hole depth into a metal workpiece, comprising:
a shank defining a drilling direction and having an axis of rotation oriented in the drilling direction, wherein the shank has a cutting edge at an end pointing in the drilling direction and has a stop shoulder at a distance from the cutting edge defining the blind hole depth and measured counter to the drilling direction, wherein the cutting edge defines the blind hole diameter by rotation about the axis of rotation, wherein the shank has an enveloping circle diameter changing along the axis of rotation and is larger at the stop shoulder than the blind hole diameter, wherein the shank has a first shank section adjoining the stop shoulder counter to the drilling direction and reaching up to the stop shoulder, the enveloping circle diameter, starting from the stop shoulder, increasing counter to the drilling direction in the first shank section.

12. The drill bit as recited in claim 11 wherein the enveloping circle diameter in the first shank section increases continuously counter to the drilling direction.

13. The drill bit as recited in claim 11 wherein the first section has a conical shape.

14. The drill bit as recited in claim 13 wherein an opening angle of the conical shape is at least 60°. in particular at least 90°, in particular at least 120°.

15. The drill bit as recited in claim 13 wherein an opening angle of the conical shape is at least 90°.

16. The drill bit as recited in claim 13 wherein an opening angle of the conical shape is at least 120°.

17. The drill bit as recited in claim 11 wherein the first section extends along the axis of rotation over at least 0.5 mm.

18. The drill bit as recited in claim 11 wherein the first section extends along the axis of rotation over at least 1.0 mm.

19. The drill bit as recited in claim 11 wherein the first section extends along the axis of rotation over at least 1.5 mm.

20. The drill bit as recited in claim 11 wherein the first section extends along the axis of rotation over at least 2.0 mm.

21. The drill bit as recited in claim 11 wherein the shank has a centering point at its end pointing in the drilling direction, the axis of rotation running through the centering point.

22. The drill bit as recited in claim 11 wherein the stop shoulder has a stop surface oriented perpendicular to the axis of rotation and pointing in the drilling direction.

23. The drill bit as recited in claim 11 wherein the shank has, at an end pointing counter to the drilling direction, a fastening section for temporary fastening to a hand-held drilling machine.

24. The drill bit as recited in claim 11 wherein the shank has, at an end pointing counter to the drilling direction, an insertion end for temporary fastening to a hand-held drilling machine.

25. A method for fastening a fastening element to a workpiece, comprising the following steps:
providing a workpiece having a cover layer;
providing a drill bit as recited in claim 11;
drilling a blind hole through the cover layer into the workpiece via the drill bit, wherein the first shank section of the drill bit produces a hole in the cover layer that increases in size counter to the drilling direction;
providing a fastening element having a sealing element; and
driving the fastening element into the blind hole, wherein the sealing element is pressed against the hole in the cover layer.

26. The method as recited in claim 25 wherein driving the fastening element into the blind hole comprises screwing the fastening element into the blind hole.
